(19) United States
(12) Patent Application Publication
(10) Pub. No.: US 2015/0146002 A1
(43) Pub. Date: May 28, 2015

(54) DOOR WITH SECURITY FEATURES AND INTEGRATED SYSTEM

(71) Applicants: David Cruz, Oxnard, CA (US); Jon Brandon Cruz, Oxnard, CA (US); Paul Cruz, San Antonio, TX (US)

(72) Inventors: David Cruz, Oxnard, CA (US); Jon Brandon Cruz, Oxnard, CA (US); Paul Cruz, San Antonio, TX (US)

(21) Appl. No.: 14/554,723

(22) Filed: Nov. 26, 2014

Related U.S. Application Data
(60) Provisional application No. 61/909,263, filed on Nov. 26, 2013.
(60) Provisional application No. 61/928,832, filed on Jan. 17, 2014.

(51) Int. Cl. H04N 7/18; G08B 13/196

(52) U.S. Cl. CPC H04N 7/183; G08B 13/196
USPC 348/156

(57) ABSTRACT

Devices and systems according to the present disclosure include doors with integrated security features, for example, surveillance devices, observation interfaces and locking mechanisms. In some embodiments, these doors can include cameras integrated into the doors, surfaces connected to the doors, or surfaces adjacent to the doors such as adjacent walls. In some embodiments, locking mechanisms integrated with the doors can be configured to send a signal activating one or more additional security features while sounding an alarm and/or alerting authorities. In some embodiments, door or adjacent surfaces can further comprise receiving compartments allowing for secure installation and access to internal surveillance equipment.

### CROSS REFERENCE TO RELATED APPLICATIONS

This application claims the benefit of U.S. Provisional Patent Application Ser. No. 61/909,263 to David Cruz, entitled BUILDING INTEGRATED SECURITY SYSTEM, which is hereby incorporated herein in its entirety by reference. This application further claims the benefit of U.S. Provisional Patent Application Ser. No. 61/928,832 to David Cruz, et al., entitled DOOR WITH SECURITY FEATURES AND INTEGRATED SYSTEM, which is also hereby incorporated herein in its entirety by reference.

### BACKGROUND OF THE INVENTION

1. Field of the Invention

The present invention relates generally to building safety, and specifically to entryways and other access points including doors and/or other partitions and security features and systems incorporated into/with these entryways.

2. Description of the Related Art

Since mankind first conceived the concept of real property and begin developing structures to serve as locations such as residences, places of business, public forums and halls of education, protecting and securing the safety of individuals within these structures has been of paramount concern. In particular, various devices and systems have been developed throughout the ages to restrict access by intruders to such structures or compartments and specific locations within such structures. Some of these devices and systems have included sturdy security doors and various locking mechanisms. In some instances, these structures further utilized additional features, such as surveillance equipment, to help identify and later prosecute an intruder.

Although such security concerns apply to many different structures, one location that has been of particular concern in recent times is the school campus, where large groups of people are particularly vulnerable to an attack that could potentially result in significant casualties. Indeed, real-world examples of the devastation of such attacks are evidenced by tragedies such as those that occurred at Columbine High School in 1999, Virginia Tech in 2007, and Sandy Hook Elementary School in 2012.

In response to such attacks, various security systems, protocols and other countermeasures have been developed to mitigate the damage of an attack and save human lives. For example, United States Pre-Grant Patent Publication US 2012/0314063 A1 to Cirker discloses a system utilizing a wireless signal to trigger a “threat-level” change, which can then send a signal to an operations center where an operator can activate various other features such as alarms and surveillance equipment.

At least some disadvantages of the above disclosed system, and others that are typically practiced, is that multiple steps or activations are required to produce a complete security response, which might include features such as locking a door, activating surveillance equipment and notifying the relevant authorities. Furthermore, in typically practiced security systems, various security features, such as cameras used to identify an intruder, may be obvious and/or exposed and thus vulnerable to tampering by the intruder.

Thus, improved tamper-resistant devices and systems for efficient and enhanced building security that allow for a one-trigger complete response are therefore needed.

### SUMMARY OF THE INVENTION

Described herein are doors with integrated security features and systems utilizing these doors and features. Doors incorporating features of the present invention can be any door, for example, a pre-existing security or non-security door that is subjected to a retrofit process utilizing features of the present invention and/or a door specifically manufactured and configured to receive various security features according to the present disclosure.

Doors incorporating features of the present invention can comprise surveillance equipment such as, for example, cameras, sensors (such as heat or motion sensors) and audio recording equipment. All or a portion of the surveillance equipment can be positioned within the door, or the surveillance equipment can be configured to be near or otherwise adjacent to the door. In some embodiments, a surveillance device, such as a camera, can be configured such that all or part of it is inside the door itself. In some embodiments, a surveillance device can further comprise additional features, such as a housing portion, to facilitate connection to a portion of the door or an adjacent structure, and to further protect the camera from damage and/or tampering. In some embodiments, a surveillance device can be placed in other locations adjacent to the door, as will be discussed in more detail below.

Doors incorporating features of the present invention can also comprise locking mechanisms. Such locking mechanisms can be configured to send and receive signals, such as electronic and/or radio frequency (RF) signals. This allows the lock to be remotely operated in response to an initial signal, and to then transmit another signal—in response to the initial signal or in response to the locking of the door itself, for example—which can activate additional security features of the door.

Doors incorporating features of the present invention can further comprise an observation interface, such as an audio device, screen or monitor, allowing an individual in a secured room or partition, such as a location behind a locked door, to perceive events occurring outside of the secured location, such as on the other side of the door.

Systems for use with doors incorporating features of the present invention can comprise a user submitted or automated signal, such as an RF signal transmitted via a key fob-like device, in which a single signal activation can be used to activate multiple security features. For example, a user, upon hearing gunshots or otherwise perceiving an intruder, can activate a remote device which causes the door to lock. An RF circuit within the locking mechanism can then transmit one or more signals that simultaneously activate surveillance equipment, an observation interface and an alarm, and/or otherwise notify a command center and/or emergency services personnel.

In one embodiment, a security system comprises a door configured to restrict or grant access to an internal area from an external area and a surveillance device configured with the door such that the surveillance device perceives at least a portion of the external area and is housed within a protective housing.

In another embodiment, a security system comprises a door configured to restrict or grant access to an internal area from an external area, the door being configured to receive at least a portion of a surveillance device configured to perceive at least a portion of the external area.

In still another embodiment, a security system comprises a signal device configured to send a first signal to activate one or more features of the security system, a door configured to restrict or grant access to an internal area from an external area, a surveillance device configured with the door such that the surveillance device perceives at least a portion of the external area, a locking mechanism integrated with the door, and an observation interface configured with the surveillance device to allow individuals in the internal area to perceive the portion of the external area.

These and other further features and advantages of the invention would be apparent to those skilled in the art from the following detailed description, taking together with the accompanying drawings, in which:

### BRIEF DESCRIPTION OF THE DRAWINGS

FIG. 1 is a schematic view of one embodiment of a door incorporating features of the present invention;

FIG. 2 is a side internal view of a receiving compartment incorporating features of the present invention;

FIG. 3 is a side internal view of a camera incorporating features of the present invention;

FIG. 4 is a side internal view of a receiving compartment interfacing with a camera according to an embodiment incorporating features of the present invention;

FIG. 5 is a side internal view of door interfacing with a camera according to an embodiment incorporating features of the present invention;

FIG. 6 is a front view of a locking mechanism incorporating features of the present invention; and

FIG. 7 is a schematic flow-diagram setting forth an embodiment of a system incorporating features of the present invention.

### DETAILED DESCRIPTION OF THE INVENTION

The present disclosure includes both specifically manufactured doors with integrated security features and pre-existing doors wherein security features according to the present disclosure are incorporated via a retrofit process. Doors incorporating features of the present invention can thus comprise any material suitable for security or non-security doors known in the art, including but not limited to metal, wood, plastics such as bullet-resistant plastics), various polymers, and combinations thereof. The entirety of doors incorporating features of the present invention can be made force-, damage- and/or bullet-resistant, or certain portions of the doors can be reinforced or otherwise made force-, damage- and/or bullet-resistant. The doors can be configured in conjunction with a sturdy doorframe, such as a metal doorframe.

Doors according to the present disclosure can be configured to conform to various environmental, safety and security standards. For example, the doors can be any level of security door from Level I to Level VIII, with a preferred level in an application such as school safety being a Level III or higher door, while in financial and governmental institutions the doors may be an even higher level. Such environmental, safety and security standards are known in the art and are therefore only discussed briefly herein.

Doors incorporating features of the present invention can also comprise one or more associated surveillance devices, which can be configured with the door such that such devices are installed at least partially inside the door itself or positioned elsewhere, for example, near or adjacent to the door. In some preferred embodiments, a surveillance device is configured such that it can observe the area directly outside the location the door grants or restricts access to by, for example, being positioned near or adjacent to the door.

Surveillance devices that can be associated with the door include any device capable of perceiving an area using, for example, visual, audio, olfactory, tactile, electromagnetic, radio, radioactive and/or echolocation processes. Some example surveillance devices that can be associated with doors according to the present disclosure include, but are not limited to, cameras (such as a camera with digital, video, photographic, wide-lens, telescopic, night-vision, low-light vision and/or infrared capabilities) and other visual devices, audio recording devices and various sensors (such as heat, motion and/or pressure sensors). Surveillance devices according to the present disclosure can comprise a variety of shapes and sizes, with the preferred dimensions being those that facilitate the protection or unobtrusive nature of the device by, for example, allowing the device to fit into a dedicated compartment in the door or a wall adjacent to the door. In some embodiments, the device comprises a video recording camera having the following dimensions: 37 mm (width)×39 mm (height)×32 mm (depth). In some embodiments, the device comprises a video recording camera having the following dimensions: 1.4 inches (width)×1.5 inches (height)×1.25 (depth). In embodiments wherein the surveillance device requires electrical power, the device can be powered via any means known in the art, including battery or outlet power.

Surveillance devices incorporating features of the present disclosure can be housed within a protective housing, for example, part of the door, a wall adjacent or near the door or an additional housing or protective portion. The housing portion can surround all or part of a surveillance device and can provide protection to the device and/or can help to conceal the device—for example, in embodiments wherein the surveillance device is adjacent to and outside of the door—by making the device less obvious by, for example, making it appear like part of an adjacent wall. The housing can be made of a sturdy material to prevent or mitigate damage to the surveillance equipment, but should be configured such that the housing does not significantly interfere with the perception abilities of the surveillance device. While box-like shaped housings are primarily shown in the figures discussed below, it is understood that the housing can comprise a variety of shapes, including but not limited to any regular or irregular polygon.

The housing can be made of any material that can provide support, enhanced protection and/or obscuring qualities (so that the housing and surveillance equipment blend in for embodiments wherein a camera is not internal to the door or is otherwise exposed). Some example materials include but are not limited to resin, rubber, vinyl, polyurethane, poly vinyl chloride (PVC), polystyrene foam, polymers/copolymer substances, acrylic substances, plastic, leather, metal, glass, fiberglass, wood, cloth or a combination thereof.

The housing can be further shaped or configured to comprise an access point, such as an aperture, allowing for enhanced perception by the surveillance device. Such an access point is particular useful in embodiments wherein the housing would otherwise interfere with the function of the surveillance device, for example, in an embodiment wherein the housing comprises an opaque material and the surveillance device comprises a visual device such as a video camera. In such an embodiment, an access point could be created within the housing, allowing the internal camera to perceive space outside the housing via the access point. In some embodiments, the access point can further interface with a portion of the surveillance device, such as an elongated portion of the camera's lens.

The housing can be configured such that it can have “opened” and “closed,” and/or “partially opened” and “partially closed” positions. Example configurations include a housing comprising a moveable or removable access portion such as a portion that allows outside access to the surveillance device. This access portion can be configured utilizing known means, such as peg and hole structures, hinge structures, complementary slot structures and sliding structures. In some embodiments, the access portion utilizes a locking mechanism or other security feature to prevent unauthorized users from accessing the surveillance device, although in embodiments wherein the device is within the door itself, or an adjacent structure such as a wall, access to the surveillance device is inherently inaccessible to an unauthorized user.

In addition to, or in lieu of, being configured with separate protective housing structures, as mentioned above, surveillance devices can further be protected by being at least partially housed within the doors or surfaces near of adjacent to the doors. Doors incorporating features of the present invention, or indeed surfaces adjacent to such doors such as adjacent walls, can further comprise receiving compartments or other dedicated areas configured to receive one or more surveillance devices. These receiving compartments can be configured to interface with a portion of the surveillance device itself and/or the housing (in embodiments wherein a housing is utilized). This can provide easy support and correct positioning of the surveillance device. In embodiments not utilizing a housing structure, a portion of the door itself can function as the housing structure's “access point” as discussed above.

In some embodiments, the receiving compartments, like the housing structures discussed above, can have “opened” and “closed,” and/or “partially opened” and “partially closed” positions. This configuration allows for a surveillance device to be secured within the door when in use, and allows the surveillance device to be removed for data retrieval (in embodiments wherein data is stored in the device rather than being transmitted to a separate location for storage) and repair/servicing. In some embodiments, the receiving compartments are only accessible from the “safe side” of the door i.e., the intended area which the door grants or restricts access to. In the example of a school campus situation, the “safe area” could be a classroom, and the door can be configured such that an intruder locked out of the classroom would not be able to access the receiving compartments from the other side of the door. Also, like the housing structures above, the receiving compartments can comprise locking mechanisms and additional features to prevent access from unauthorized users.

Doors incorporating features of the present invention can further comprise locking mechanisms. These locking mechanisms can comprise restrictive closure features that are known in the art, such as a mortise or dead-bolt configuration. The locking mechanism can further comprise a receiving and/or sending RF circuit. This allows the locking mechanism to be operated remotely and to send a signal to activate further security features upon being triggered. In some embodiments, the locking mechanism has an “emergency lockdown” mode in which locking the door initiates further security protocols, such as activation of surveillance devices and alarms, and a “non-emergency locking” mode, with which an individual can, for example, trigger the routine locking of a door at the end of a business day.

In some embodiments incorporating features of the present invention, the locking mechanism presents a keyless, structurally sound, metal, exterior surface with an electronic keypad, and on the interior side, presents a single keyless metal surface with a small window-like space though which a RF signal can be received. In some embodiments, the locking mechanism also presents a separate on-board Wi-Fi (Receive-Send) circuit, which can be battery-powered, and a PC board contained within a smaller housing installed on a portion of the locking mechanism in a small window-like space covered by a material. A user-submitted RF signal is received through the material which locks the door, and which in turn is sent, resulting in alerting others and/or deployment/activation of additional security features such as the activation of surveillance equipment, the activation of an observation interface, and/or the activation of an alarm or signal transmission to relevant authorities.

Doors incorporating features of the present invention can further comprise an observation interface, such as an audio device, screen or monitor, allowing an individual in a secured room or partition, such as a location behind a locked door according to the present disclosure, to perceive events occurring outside of the secured location, such as on the other side of the door, which are perceived via the associated surveillance devices discussed above. The dimensions of the observation interface are determined by the distance from which a user can safely observe the observation interface during a lockdown situation. In some embodiments, the observation interface is located diagonally above and adjacent to the door with the angle of placement being slightly downward and facing toward the safest area of the room, secured by the door in the event of an active threat.

Doors incorporating features of the present invention can further comprise one or more wiring harnesses to provide power to various security features. In some embodiments, the doors comprise two wiring harnesses. The first wiring harness can be a configuration of electrical wires utilized to serve as positive, negative and neutral power conduits designed to provide power to a surveillance device and an observation interface. The first wiring harness can be housed inside of a flexible loom (such as an organizational structure or portion) or tubing and routed between the outer and inner facing door-walls, with one end connected to the surveillance device and the other end to a power supply. A second wiring harness can comprise a single pair of video wires housed within an outer loom or cable insulated against external signal interference. The video cable connects at one end to the surveillance device and at its other end to the observation interface. It is also understood that doors according to the present disclosure can comprise wireless embodiments utilizing, for example, additional radio signals or Bluetooth® technology, powered by on-board power supplies and/or batteries.

Throughout this description, the preferred embodiment and examples illustrated should be considered as exemplars, rather than as limitations on the present invention. As used herein, the term “invention,” “device,” “method,” “present invention,” “present device” or “present method” refers to any one of the embodiments of the invention described herein, and any equivalents. Furthermore, reference to various feature(s) of the “invention,” “device,” “method,” “present invention,” “present device” or “present method” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. It is also understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “outer”, “above”, “lower”, “below”, “horizontal,” “vertical” and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the term “and/or” includes any and all combinations of one or more of the associated list items.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” when used herein, specify the presence of stated features, integers, steps, operations, elements, and/or components, but do not preclude the presence or addition of one or more other features, integers, steps, operations, elements, components, and/or groups thereof.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing.

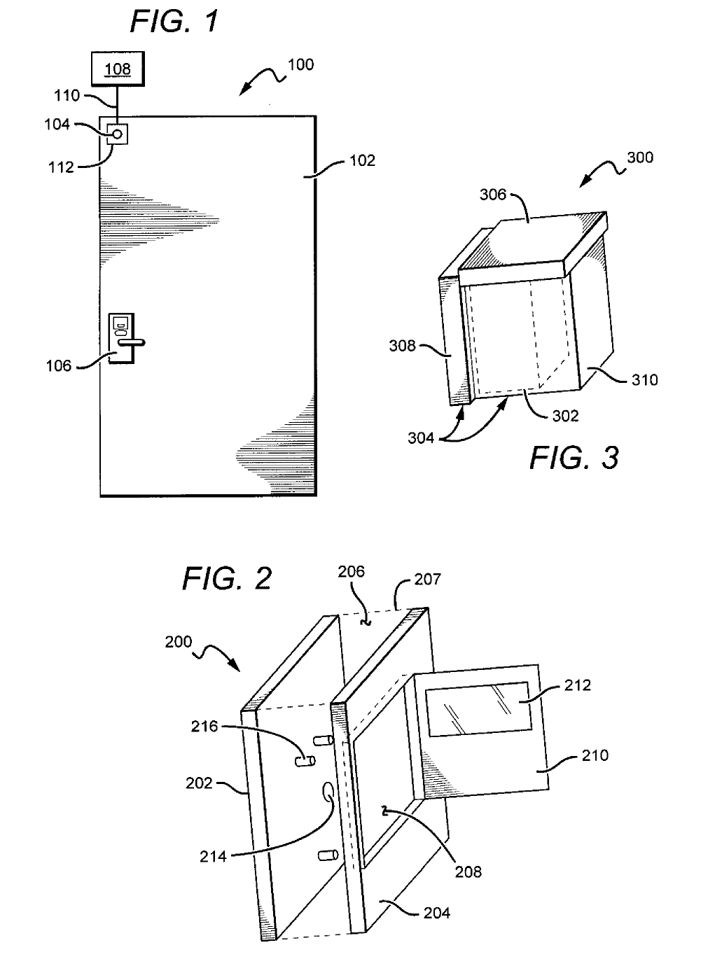

FIG. 1 shows a schematic representation 100 of a door 102 incorporating security features in accordance with the present disclosure. The security features shown include a camera 104, a locking mechanism 106 and a monitor 108, which can be connected to the camera 104 via a wiring harness 110. It is understood that the monitor 108 can also be connected to the camera 104 via other structures, such as wireless configurations as discussed above. As shown in FIG. 1, the camera 104 can be placed in an inconspicuous and/or unobtrusive position, such as in an upper corner of the door 102. This makes the camera 104 less obvious to an intruder. The camera can be angled from this position in a downward and diagonal direction to provide a wide view of the area outside of the door (i.e. the area outside of the location the door grants or restricts access to). While the camera 104 is shown as being internal to the door 102, it is understood that the camera can also be adjacent to the door, such as within the door frame of an adjacent wall, or can be a distance from the door but with capabilities to allow a user to view the space immediately outside the door via the monitor 108. The camera 104 can be within the door 102 within a receiving compartment 112 as discussed above.

Referring now to FIG. 2, which shows a receiving compartment 200 similar to receiving compartment 112 above; an external outer surface 202 of the door or a wall adjacent to the door (i.e. outside of the room or location the door restricts or grants access to) and an internal outer surface 204 of the door of a wall adjacent to the door (i.e. inside of the room or location the door restricts or grants access to) are shown. Between the external outer surface 202 and the internal outer surface 204 there is a hollow receiving portion 206, which can further comprise a bullet-resistant insulation. The door or adjacent surface can be otherwise solid except for the receiving portion 206 of the receiving compartment 200. The receiving compartment 200 can further comprise a window 208, which can serve as a structure by which to access the receiving portion 206. The window 208 can be outfitted with a moveable access panel 210 which can provide the window 208 with “open” and “closed” positions. The access panel 210 can be configured moveably with the window 208 in any way that allows for a user to restrict or grant access to receiving portion 206. Some example arrangements include but are not limited to sliding structures, complementary structures for free removability and attachment, pivot joints, ball and socket joints, condyloid (ellipsoid) joints, saddle joints and hinge joints, including living hinges. The moveable access panel 210 can further comprise a signal-window 212 to facilitate transmission of radio or other Wi-Fi signals to and/or from surveillance devices within the receiving compartment 200.

The receiving compartment 200 can further comprise an access point 214, which can allow a surveillance device, such as a camera internal to receiving compartment 200, to perceive events happening on the other side of the door's external outer surface 202, even if portions of the surveillance device are blocked by a solid metal portion of the door's external outer surface 202. In some embodiments, the access point 214 is small in size and thus limits the exposure of an internal surveillance device to damage and/or tampering by an intruder. For example, in embodiments wherein a camera is placed within the receiving compartment 200 and the access point 214 is a pin-hole size, an intruder would find it difficult to tamper with or damage the camera as there is substantially limited access to the camera. This beneficial effect is further increased in embodiments where the receiving compartment 200 is located in a higher and less obtrusive location as is shown in FIG. 1.

The receiving compartment 200 in FIG. 2 can further comprise connecting structures 216 which can be configured to interact with a corresponding structure on a surveillance device or intermediate structure connected to a surveillance device—for example, a housing structure—in order to secure the surveillance device in place within the receiving portion 206. Examples of such complimentary structures include a peg-and-hole structure (as shown), hook and loop structures (such as Velcro®), button structures, snap-fit structures and any structure designed with two or more complimentary portions configured to interact or mate together.

FIG. 3 shows a surveillance device 300 which comprises a camera 302, a housing 304 and one or more Wi-Fi circuits 306. As discussed above, the housing can comprise various structures to allow access to the camera 302. For example, the housing 304 can comprise a first portion 308 and a second portion 310 configured to fit together such that they can be securely conjoined, yet be removable by an intentional and directed manual force. The Wi-Fi circuits 306 can be configured to receive and/or send signals activating the camera 302 and/or activating additional security devices in response to the camera being activated and/or an activation signal being received. The first portion 308 of the housing can be configured to interact with connecting structures within the receiving compartment of the door.

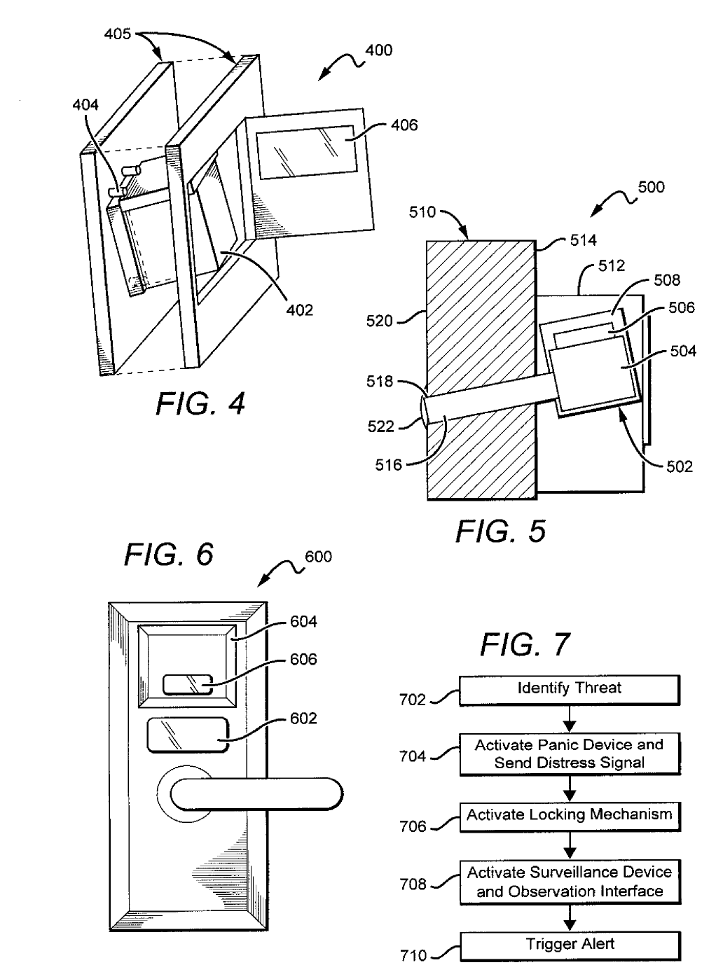

FIG. 4 depicts a security feature arrangement 400, in which a surveillance device 402, similar to surveillance device 300 in FIG. 3 above, interacts with the connecting structures 404 of a receiving compartment 405, which are similar to connecting structures 216 in FIG. 2 above. An access panel 406 can then be moved into a “closed” position in order to secure the surveillance device 402 within the receiving compartment 405. In some embodiments, the receiving compartment 405 further comprises “track-like” structures that can guide and secure a surveillance device 402 within the receiving compartment.

One advantage of utilizing a housing structure at least partially surrounding a surveillance device is that the surveillance device can be removed and replaced from a receiving compartment with less wear on the surveillance device itself. Furthermore, the housing helps to further insulate and protect the surveillance device from trauma experienced by the door.

FIG. 5 shows another embodiment 500 incorporating features of the present invention. FIG. 5 shows a surveillance device 502, similar to the surveillance device 300 in FIG. 3 above, comprising a camera 504, a Wi-Fi circuit 506, and a housing 508. Unlike the embodiment shown in FIG. 4 above, the embodiment 500 in FIG. 5 has the surveillance device 502 not within the door 510, but instead within an adjacent structure 512 connected to the door 510 on its internal outer surface 514. The surveillance device 502 further comprises an elongated lens 516 that travels through the door 510, for example, the entirety of said door 510 as shown, to access point 518, and allows the surveillance device 502 to observe the space on the other side of the external outer surface 520 of the door 510. Like in FIG. 4 above, the surveillance device is freely removable and replaceable such that it can be removed and replaced into the adjacent structure 512 and can be connected or disconnected from the elongated lens 516 as desired based on the needs of a user. This arrangement further protect the surveillance device 502 from trauma inflicted upon the door 510. The access point 518 can further comprise a cover 522 which can provide additional protection for the elongated lens 516. Other embodiments disclosed herein comprising an access point can also include a cover for protecting the surveillance device adjacent the access point.

FIG. 6 shows an example locking mechanism 600 incorporating features of the present invention. The locking mechanism can comprise a receiving window 602, allowing the locking mechanism 600 to receive a signal, for example a Wi-Fi signal, activating the locking mechanism. The locking mechanism can further comprise a separate on-board Receive/Send battery-powered circuit board contained within a smaller metal housing 604, installed on the locking mechanism 600 with a second window 606, through which a signal can be received, and which in turn can send an alert and/or activate additional security features. This allows a single signal activating the lock to set off a chain reaction activating other features, without multiple actions needed to be taken by a user.

FIG. 7 depicts a flow chart of a system incorporating features of the present invention. In a first step 702, a threat, such as an armed intruder in a building structure, is identified. This can be due to identification by an individual at a command center constantly monitoring the structure, or by an individual present at the structure—for example, an employee working at the structure. Alternatively, an automated alarm can be activated due to the detection of a hazardous condition. For example, if surveillance monitoring had shape-recognition software and detected the presence of an armed individual, or an audio or chemical sensor detected the presence of a discharged firearm, such an alarm could be activated.

In a second step 704, an individual alerted to the presence of a threat can activate a panic or signal device and send out a distress signal to activate one or more security features, such as a locking mechanism, surveillance equipment or user interface as discussed above. The panic device can comprise a variety of features and can be similar in design to a wireless key-fob device which can be worn. Alternatively or in addition, the panic device can be at a stationary or hidden location—for example, under a teacher's desk in a class room—and can be wireless or wired. In some embodiments, the signal is unique to a certain room or place within the building structure. For example, in the case of school campus safety, a teacher's individual panic device can correspond to his or her classroom alone. This allows for an individualized lockdown, as a general lockdown may result in people being locked out of the safety of a classroom in the event of a total lockdown.

In a third step 706, upon receiving an distress signal, a locking mechanism associated with a door to a particular room in which the individual activating the signal is in activates and immediately deploys a closure mechanism, placing the room in lockdown mode. In a fourth step 708, which can occur simultaneously with the third step 706, the distress signal can activate a surveillance device and an observation interface. In a fifth step 710, which can occur simultaneously with the third 706 and fourth steps 708, the distress signal can trigger an alert system, activating an alarm and/or notifying a security command center and/or the necessary authorities and emergency services. As discussed above, one way this simultaneous security protocol is executed is by having an RF circuit within the locking mechanism that is capable of sending the necessary signal to the various other security features (e.g. surveillance device, observation interface and alarm/authorities contact) in response to the locking mechanism receiving the distress signal.

Although the present invention has been described in detail with reference to certain preferred configurations thereof, other versions are possible. Embodiments of the present invention can comprise any combination of compatible features shown in the various figures, and these embodiments should not be limited to those expressly illustrated and discussed. Therefore, the spirit and scope of the invention should not be limited to the versions described above.

The foregoing is intended to cover all modifications and alternative constructions falling within the spirit and scope of the invention.

We claim:

1. A security system, comprising:
a door configured to restrict or grant access to an internal area from an external area; and
a surveillance device configured with said door such that said surveillance device perceives at least a portion of said external area, said surveillance device housed within a protective housing.

2. The security system of claim 1, wherein said door is bullet-resistant.

3. The security system of claim 1, wherein said protective housing comprises a portion of said door.

4. The security system of claim 3, wherein said door further comprises a receiving compartment configured to receive said surveillance device, and an access panel configured to grant or restrict access to said receiving compartment.

5. The security system of claim 1, wherein said protective housing comprises a portion of a wall adjacent to said door.

6. The security system of claim 5, wherein said door further comprises a receiving compartment configured to receive said surveillance device and an access panel configured to grant or restrict access to said receiving compartment.

7. The security system of claim 1, further comprising an observation interface configured with said surveillance device to allow individuals in said internal area to perceive said at least a portion of said external area.

8. The security system of claim 1, further comprising a locking mechanism, said locking mechanism configured to receive a signal to lock or unlock said door and configured to send a signal activating additional security features.

9. The security system of claim 8, wherein said additional security features include said surveillance device.

10. The security system of claim 8, wherein said additional security features include an alert system.

11. A security system, comprising:
a door configured to restrict or grant access to an internal area from an external area, said door configured to receive at least a portion of a surveillance device, said surveillance device configured to perceive at least a portion of said external area.

12. The security system of claim 11, wherein said door is configured to receive a lens portion of a surveillance device such that said lens portion travels through said door.

13. The security system of claim 11, further comprising a receiving compartment configured to receive the entirety of said surveillance device, and an access panel configured to grant or restrict access to said receiving compartment.

14. The security system of claim 13, wherein said receiving compartment comprises structures for securing said surveillance device to said receiving compartment.

15. The security system of claim 13, wherein said receiving compartment is internal to said door.

16. The security system of claim 13, wherein said receiving compartment is internal to a structure adjacent and connected to said door.

17. A security system, comprising:
a signal device configured to send a first signal to activate one or more features of said security system;
a door configured to restrict or grant access to an internal area from an external area;
a surveillance device configured with said door such that said surveillance device perceives at least a portion of said external area;
a locking mechanism integrated with said door; and
an observation interface configured with said surveillance device to allow individuals in said internal area to perceive said at least a portion of said external area.

18. The security system of claim 17, wherein said signal device is configured to activate said locking mechanism and lock said door.

19. The security system of claim 18, wherein said locking mechanism is further configured to send a second signal activating one or more other features of said security system and sending an alert to law enforcement authorities in response to said locking mechanism being activated by said first signal.

20. The security system of claim 17, wherein said surveillance device, said locking mechanism and said observation interface are configured to simultaneously activate in response to said first signal.
